(19) United States
(12) Patent Application Publication
(10) Pub. No.: US 2017/0188341 A1
(43) Pub. Date: Jun. 29, 2017

(54) Method, Apparatus and System for Processing Downlink Control Channels

(71) Applicant: Beijing Xinwei Telecom Technology Inc., Beijing (CN)

(72) Inventors: Yuanchun Tan, Beijing (CN); Wenzhong Zhang, Beijing (CN); Qihua Huang, Beijing (CN); Ruifeng Xu, Beijing (CN)

(21) Appl. No.: 15/309,455

(22) PCT Filed: Dec. 2, 2014
(86) PCT No.: PCT/CN2014/092770

§ 371 Date: Nov. 8, 2016

(30) Foreign Application Priority Data
Dec. 3, 2013 (CN) 201310642353.7

(51) Int. Cl. H04W 72/04; H04W 76/04; H04W 48/12

(52) U.S. Cl. CPC H04W 72/042; H04W 48/12; H04W 76/046; H04W 72/0446

(57) ABSTRACT

The application provides a method for processing a downlink control channel, including: in a downlink Transmit Time Interval (TTI), when a User Equipment (UE) of a group call in a cell has an individual service to be scheduled, a sender schedules a service of the group call within public space, by using a Group Radio Network Temporary Identifier (G-RNTI), and schedules the individual service within dedicated space by using a Cell Radio Network Temporary Identifier (C-RNTI); in the downlink TTI, when no UE in the group call of the cell has an individual service to be scheduled, the sender schedules the service of the group call within the dedicated space by using the G-RNTI.

The application claims the benefit of Chinese application No.201310642353.7, filed on Dec. 3, 2013, entitled “downlink control channel processing method, apparatus and system”, which is incorporated herein by reference in its entirety.

### TECHNICAL FIELD

The present disclosure relates to radio communication technologies, and more particularly, to a method, apparatus and system for processing downlink control channels.

### BACKGROUND

In a long term evolution (LTE) cluster system, in addition to Radio Network Temporary Identifier (RNTI) supported by the original LTE standard, Group Paging RNTI (GP-RNTI) and Group RNTI (G-RNTI) supporting cluster services have been added. GP-RNTI is used for paging of group users. G-RNTI is used for physical-layer scrambling of group signaling and services.

Space occupied by RNTI-scrambling control commands on control channel elements (CCE) is divided into public space and dedicated space. The public space is shared by a number of public orders. The dedicated space can be shared by multiple users, and also can be used by one user. The public space starts from index 0 of fixed CCE space. A terminal searches in the dedicated space from a starting point determined by Cell RNTI (C-RNTI).

The foregoing paging commands with GP-RNTI scrambling are generally stored in the public space, while the downlink group services commands with G-RNTI scrambling can be stored by the public space, or the dedicated space. When G-RNTI scrambling commands are stored in the public space with insufficient public resources, G-RNTI will occupy limited public space, thereby reducing system throughput. When G-RNTI is stored by the dedicated space with relatively sufficient resources, complexity of searching space by a user equipment (UE) may be increased, which puts forward a higher requirement for UE's battery capacity.

To solve the above problems, applicant puts forward a method: allocate G-RNTI for cluster services within the dedicated space, and schedule the cluster service by using the G-RNTI; for a UE in a radio resource control_Connected (RRC_Connected) state of a cluster service group, when there are cluster service and UE individual service at the same time, firstly combine the cluster service with the UE individual service, then schedule the combined service by using C-RNTI of the UE; receiver: in a downlink transmit time interval (TTI), perform a blind detection within the dedicated space, by using a set of G-RNTIs or a set of C-RNTIs and G-RNTIs; the blind detection is terminated once detecting any RNTI.

The applicant also puts forward another method: when there is a G-RNTI cluster service in a downlink TTI, schedule the cluster service by using the G-RNTI; for each UE of a cluster service group, if there is a UE individual service in the downlink TTI, not schedule the UE individual service within the TTI, and schedule the UE individual service in a next downlink TTI. In a downlink TTI, a UE performs a physical downlink control channel (PDCCH) blind detection within the dedicated space, by using a set of G-RNTIs or a set of C-RNTIs and G-RNTIs.

By using the above two methods, although number of blind detection performed by a terminal can be significantly reduced, it is still necessary to perform additional 4 PDCCH blind detections at most.

### SUMMARY

The present disclosure puts forward a method for allocating a downlink control channel, including:
under the circumstances that there is a service of group call to be scheduled in a downlink transmit time interval (TTI),
when a user equipment (UE) of the group call within a cell has an individual service to be scheduled in the downlink TTI,
scheduling, by a sender, the service of the group call in public space, by using a Group Radio Network Temporary Identifier (G-RNTI) or a Semi-Persistent Scheduling (SPS) G-RNTI, and scheduling the individual service of the UE within dedicated space, by using a Cell Radio Network Temporary Identifier (C-RNTI) or a SPS C-RNTI;
when each UE of the group call within the cell has no individual service to be scheduled in the downlink TTI, scheduling, by the sender, the service of the group call within the dedicated space, by using the G-RNTI or the SPS G-RNTI.

The scheduling is a dynamic scheduling or the SPS. There is at least one service of the group call. There is at least one UE having the individual service to be scheduled in the downlink TTI. The individual service is a point-to-point service. The UE having the individual service to be scheduled in the downlink TTI is in a Radio Resource Control_Connected (RRC_Connected) state.

The method further includes:
before scheduling by the sender the service of the group call, determining whether there is a UE of the group call having an individual service to be scheduled in the downlink TTI;
wherein determining whether there is the UE of the group call having the individual service to be scheduled in the downlink TTI includes:
learning from a network side whether the UE having the individual service to be scheduled belongs to the group call; or,
learning from the network side the UE participating in the group call, monitoring the UE within the cell having the individual service to be scheduled, and determining whether the UE belongs to the group call.

The present disclosure also provides an apparatus for processing a downlink control channel, including a first scheduling module and a second scheduling module,
when there is a service of a group call to be scheduled in a downlink TTI, the first scheduling module is to schedule the service of the group call, which includes:
when a UE of the group call has an individual service to be scheduled in the downlink TTI, schedule the service of the group call within public space, by using a G-RNTI or a SPS G-RNTI;
when no UE of the group call has an individual service to be scheduled in the downlink TTI, schedule the service of the group call within dedicated space, by using the G-RNTI or the SPS G-RNTI;
when a UE of the group call has an individual service to be scheduled in the downlink TTI, the second scheduling module is to schedule the individual service of the UE within the dedicated space, by using a Cell Radio Network Temporary Identifier (C-RNTI) or a SPS C-RNTI.

The apparatus further includes a service monitoring module, which is to monitor whether each UE of the group call in a cell has an individual service to be scheduled in the downlink TTI, inform the first scheduling module and the second scheduling module.

The monitoring includes:
learning from a network side whether the UE having the individual service to be scheduled belongs to the group call; or,
learning from the network side the UE participating in the group call, monitoring the UE of the cell having the individual service to be scheduled, and determining whether the UE belongs to the group call.

The scheduling is a dynamic scheduling or a SPS. There is at least one service of the group call. There is at least one UE having the individual service to be scheduled in the downlink TTI. The individual service is a point-to-point service.

The present disclosure also provides a method for processing a downlink control channel, including:
performing, by a UE, a PDCCH blind detection within public space in a downlink TTI, by using a G-RNTI or a SPS G-RNTI;
when not detecting the G-RNTI and the SPS G-RNTI, continuously performing, by the UE, the PDCCH blind detection within dedicated space, and exiting the PDCCH blind detection.

The method further includes:
when detecting the G-RNTI or the SPS G-RNTI within the public space by the UE, and the UE is in a radio resource control_Idle (RRC_Idle) state, exiting the PDCCH blind detection.

The method further includes:
when detecting the G-RNTI or the SPS G-RNTI within the public space by the UE, and the UE is in an RRC_Idle state, continuously performing the PDCCH blind detection within the dedicated space, by using a C-RNTI or a SPS C-RNTI, and exiting the PDCCH blind detection.

The present disclosure also provides a terminal for processing a downlink control channel, including a first module,
wherein the first module is to perform a PDCCH blind detection within public space in a downlink TTI, by using a G-RNTI or a SPS G-RNTI;
when not detecting the G-RNTI and the SPS G-RNTI within the public space, continuously performing the PDCCH blind detection within dedicated space, and exiting the PDCCH blind detection.

When detecting the G-RNTI or the SPS G-RNTI within the public space, and the terminal is in a RRC_Idle state, the first module is further to exit the PDCCH blind detection.

The terminal further includes a second module;
when detecting the G-RNTI or the SPS G-RNTI within the public space, and the terminal is in an RRC_Connected state, the second module is to perform the PDCCH blind detection within the dedicated space, by using a C-RNTI or a SPS C-RNTI, and exit the PDCCH blind detection.

The terminal further includes a third module, which is to record whether the terminal is in an RRC_Connected state or RRC_Idle state.

The present disclosure also provides a system for processing a downlink control channel. The system includes any of the apparatuses and the terminals described above.

By adopting method, apparatus and system for processing a downlink control channel of the present disclosure, not only concurrent scheduling of multiple groups of cluster services is supported, but also gain of a cluster service system is improved. Meanwhile, it is not necessary for a UE to perform additional blind detections, thereby reducing searching complexity performed by the UE.

### BRIEF DESCRIPTION OF THE DRAWINGS

FIG. 1 is a flow chart illustrating a processing method performed by a sender, in accordance with an embodiment of the present disclosure;

FIG. 2 is a flow chart illustrating a processing method performed by a receiver, in accordance with an embodiment of the present disclosure;

FIG. 3 is a flow chart illustrating processing at a network side in Embodiment 1;

FIG. 4 is a flow chart illustrating processing at UE0 side in Embodiment 1;

FIG. 5 is a flow chart illustrating processing at UE1 side in Embodiment 1;

FIG. 6 is a flow chart illustrating processing at a network side in Embodiment 2;

FIG. 7 is a flowchart illustrating processing at a terminal side in Embodiment 2;

FIG. 8 is a schematic diagram illustrating structure of an apparatus for processing a downlink control channel, in accordance with an embodiment of the present disclosure;

FIG. 9 is a schematic diagram illustrating structure of a terminal for processing a downlink control channel, in accordance with an embodiment of the present disclosure;

FIG. 10 is a schematic diagram illustrating structure of another apparatus for processing a downlink control channel, in accordance with an embodiment of the present disclosure;

FIG. 11 is a schematic diagram illustrating structure of another apparatus for processing a downlink control channel, in accordance with an embodiment of the present disclosure.

### DETAILED DESCRIPTION

For reference and clarity, descriptions of technical terms used are summarized below:

LTE: Long Term Evolution system;

RNTI: Radio Network Temporary Identifier;

GP-RNTI: Group Paging RNTI;

G-RNTI: Group RNTI;

CCE: Control Channel Elements;

C-RNTI: Cell-RNTI;

UE: User Equipment;

TTI: Transmit Time Interval;

PDCCH: Physical Downlink Control Channel

SPS: Semi-Persistent Scheduling

RRC: Radio Resource Control

Specific flows of the method for processing a downlink control channel, specific structures of corresponding apparatus and system of the present disclosure will be described in detail, accompanying with the following embodiments.

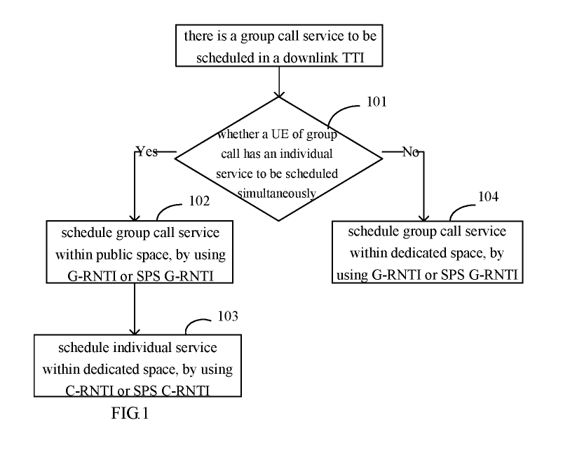

Refer to FIG. 1, FIG. 1 is a flow chart illustrating a method for processing a downlink control channel at a sender, in accordance with an embodiment of the present disclosure. Specific operations are as follows.

When there is a group call service to be scheduled in a downlink TTI, proceed with block 101.

In block 101, a sender determines, within the group call of a cell, whether a UE has an individual service to be scheduled in a downlink TTI at the same time. When determining there is a UE having an individual service to be scheduled in the downlink TTI simultaneously, proceed with block 102; when determining that no UE in the group call of the cell has an individual service to be scheduled in the downlink TTI, proceed with block 104.

In block 102, the sender schedules the group call service within the public space, by using G-RNTI or SPS G-RNTI, and then proceeds with block 103.

In block 103, the sender schedules the individual service within the dedicated space, by using C-RNTI or SPS C-RNTI.

In block 104, the sender schedules the group call service within the dedicated space, by using G-RNTI or SPS G-RNTI.

Scheduling can be dynamic scheduling, or SPS. The foregoing individual service can be a point-to-point service. There may be at least one group call service to be scheduled in a downlink TTI. Each group call service can be scheduled, by using the above method.

Block 101 may be implemented with the following method. Learn from a network side whether a UE, which has an individual service to be scheduled, belongs to the group call; or, learn from the network side a UE participating in the group call, monitor a UE having an individual service to be scheduled within the cell, and determine whether the UE belongs to the group call.

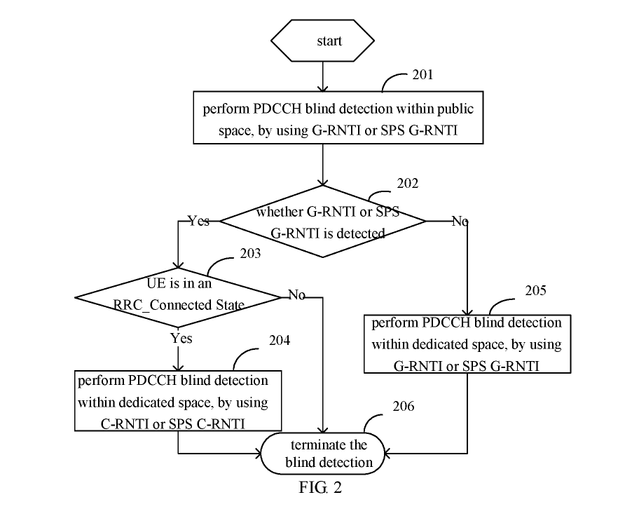

Refer to FIG. 2, FIG. 2 is a flow chart illustrating a method for processing a downlink control channel at a receiver, in accordance with an embodiment of the present disclosure. Specific operations include the following blocks.

In block 201, in a downlink TTI, a UE firstly performs a PDCCH blind detection within public space, by using G-RNTI or SPS G-RNTI, and then proceeds with block 202.

In block 202, the UE determines whether G-RNTI or SPS G-RNTI is detected, during the process of performing the PDCCH blind detection within the public space. If neither G-RNTI nor SPS G-RNTI is detected by the UE within the public space, proceed with block 205; if either G-RNTI or SPS G-RNTI is detected by the UE within the public space, proceed with block 203.

In block 203, the UE determines whether the UE is in an RRC_Connected state. When determining the UE is in the RRC_Connected state, proceed with block 204; otherwise, proceed with block 206.

In block 204, the UE continuously performs the PDCCH blind detection within the dedicated space, by using C-RNTI or SPS C-RNTI, and then proceed with block 206.

In block 205, the UE performs the PDCCH blind detection within the dedicated space, by using G-RNTI or SPS G-RNTI, and then proceed with block 206.

In block 206, the UE terminates the PDCCH blind detection.

By using the above method, multiple groups of cluster services may be supported by the system effectively, without increasing the number of blind detections performed by the UE to the downlink control channel.

Specific descriptions about some applications of the above methods will be provided in the following, accompanying with Embodiment 1 and Embodiment 2:

### Embodiment 1

For example, there are three UEs in a cell of a base station, which are UE0˜UE2 respectively. In the cell, there is a cluster service with G-RNTI 15, which corresponds to UE0˜UE2 respectively. UE0 is in an RRC_Connected state. UE1 and UE2 are respectively in an RRC_Idle state. If C-RNTI of UE0 is 5, there are cluster-group paging services of G-RNTI and data downloading services of UE0 at the same time in a certain downlink TTI.

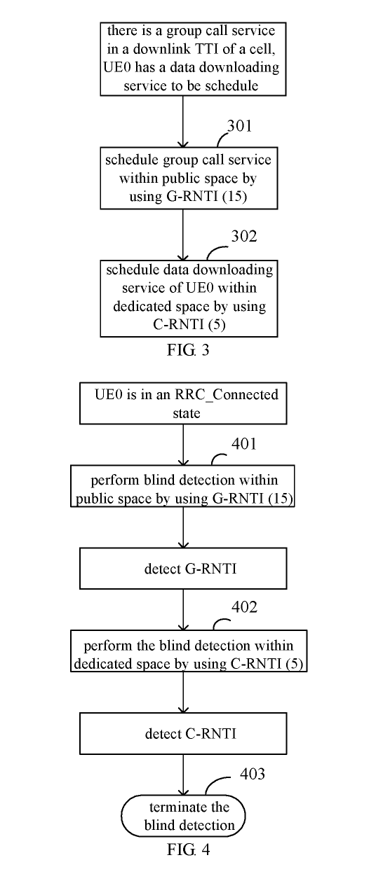

For the processing flow at sender, i.e., at the base station side, please refer to FIG. 3. According to the above descriptions, it can be seen that there is a group call service in a downlink TTI of the cell. Meanwhile, UE0 has a data downloading service to be scheduled in such downlink TTI. For the base station side, i.e., the network side, processing flow includes the following blocks.

In block 301, schedule the group call service within public space, by using G-RNTI, i.e., 15, and then proceed with block 302.

In block 302, schedule the data downloading service of UE0 within dedicated space, by using C-RNTI, i.e., 5.

For the processing flow at receiver, i.e., at UE0 side, refer to FIG. 4. According to the above descriptions, it can be seen that UE0 is in an RRC_Connected state in a downlink TTI. Subsequently, the processing flow at UE0 side includes the following blocks.

In block 401, UE0 performs a PDCCH blind detection within public space, by using G-RNTI, i.e., 15. When detecting G-RNTI, proceed with block 402.

In block 402, UE0 continuously performs the PDCCH blind detection within the dedicated space, by using C-RNTI, i.e., 5. When detecting C-RNTI, proceed with block 403.

In block 403, UE0 terminates the PDCCH blind detection.

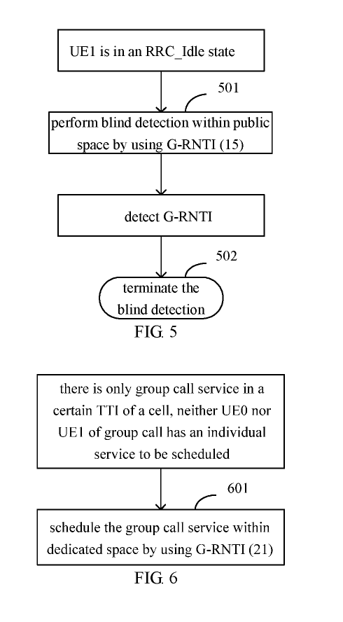

For the processing flow at receiver, i.e., at UE1 side, refer to FIG. 5. According to the above descriptions, it can be seen that UE1 is in an RRC_Idle state in a downlink TTI. Subsequently, the processing flow at UE1 side includes the following blocks.

In block 501, UE1 performs a PDCCH blind detection within public space, by using G-RNTI, i.e., 15. When detecting G-RNTI, proceed with block 502.

In block 502, UE1 terminates the PDCCH blind detection.

The processing flow at UE2 side is the same as that at UE1 side, which is not repeated here.

### Embodiment 2

For example, there are two UEs in a cell of a base station, which are UE0˜UE1 respectively. In the cell, there is a cluster service with G-RNTI 21, which corresponds to UE0˜UE1 respectively. UE0 is in an RRC_Idle state. UE1 is in an RRC_Connected state. If C-RNTI of UE1 is 17, there are only cluster-group paging services of G-RNTI in a downlink TTI.

For the processing flow at sender, i.e., at the base station side, please refer to FIG. 6. According to the above descriptions, it can be seen that there is a group call service of a cell in a downlink TTI. Within such TTI, each UE (UE0 and UE1) of the group call has no individual service to be scheduled. Subsequently, the processing flow at sender, i.e., at the network side, includes the following blocks.

In block 601, schedule the group call service within dedicated space, by using G-RNTI, i.e., 21.

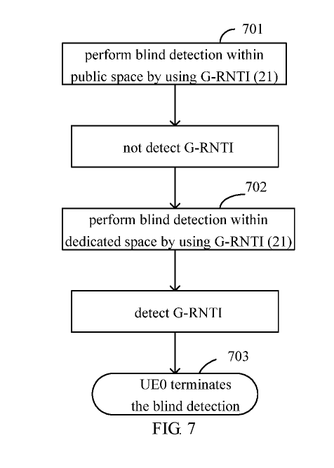

Regarding the processing flow at receiver, please refer to FIG. 7.

According to the above descriptions, it can be seen that UE0 is in an RRC_Idle state in a downlink TTI. The processing flow at UE0 side is as follows.

In block 701, UE0 firstly performs a blind detection within public space, by using G-RNTI, i.e., 21. When not detecting the G-RNTI, proceed with block 702.

In block 702, UE0 continuously performs the PDCCH blind detection within the dedicated space, by using G-RNTI, i.e., 21. When detecting the G-RNTI, proceed with block 703.

In block 703, UE0 terminates the PDCCH blind detection.

According to the above descriptions, it can be seen that UE1 is in an RRC_Connected state in a downlink TTI. The processing flow at UE1 side is as follows (not shown in FIG. 7).

UE1 performs the PDCCH blind detection within public space. When not detecting the G-RNTI within the public space, UE1 continuously performs the PDCCH blind detection within dedicated space, by using G-RNTI. After detecting the G-RNTI, terminate the PDCCH blind detection.

### Embodiment 3

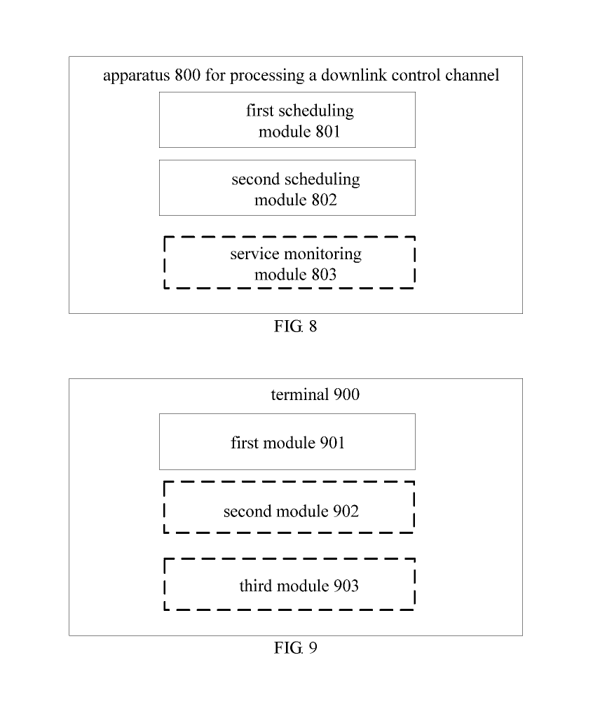

As shown in FIG. 8, Embodiment 3 of the present disclosure discloses an apparatus 800 for processing a downlink control channel, which includes a first scheduling module 801 and a second scheduling module 802. The first scheduling module 801 is configured to schedule a group call service, which includes as follows. In a downlink TTI, when a UE of the group call has an individual service to be scheduled, schedule the group call service within public space, by using G-RNTI or SPS G-RNTI; still in the downlink TTI, when each UE in the group call has no individual service to be scheduled, schedule the group call service within dedicated space, by using G-RNTI or SPS G-RNTI. When a UE of the group call has an individual service to be scheduled in such downlink TTI, the second scheduling module 802 is configured to schedule the individual service of the UE within the dedicated space, by using C-RNTI or SPS C-RNTI.

Furthermore, the apparatus includes a service monitoring module 803, which is configured to monitor, whether each UE of the group call in a cell has an individual service to be scheduled in the downlink TTI, inform the first scheduling module 801 and the second scheduling module 802. The monitoring includes as follows. Learn from a network side whether the UE having an individual service to be scheduled belongs to the group call; or learn from the network side the UE participating in the group call, monitor the UE within the cell having an individual service to be scheduled, and determine whether the UE belongs to the group call.

The scheduling is dynamic scheduling or SPS. There is at least one group call service. In the downlink TTI, there is at least one UE having an individual service to be scheduled. The individual service is a point-to-point service.

### Embodiment 4

As shown in FIG. 9, Embodiment 4 of the present disclosure discloses a terminal 900, which includes a first module 901. The first module 901 is configured to perform a PDCCH blind detection within public space in a downlink TTI, by using G-RNTI or SPS G-RNTI in a downlink TTI. When not detecting the G-RNTI and SPS G-RNTI within public space, the first module 901 is further configured to continuously perform the PDCCH blind detection within dedicated space, and then terminate the PDCCH blind detection.

When detecting the G-RNTI or SPS G-RNTI within the public space, during the process of performing the PDCCH blind detection, and the terminal is in an RRC_Idle state, the first module 901 is further configured to exit the PDCCH blind detection.

The terminal further includes a second module 902. After detecting G-RNTI or SPS G-RNTI within the public space, during the process of performing the PDCCH blind detection, and the terminal is in an RRC_Connected state, the second module 902 is configured to perform the PDCCH blind detection within the dedicated space, by using C-RNTI or SPS C-RNTI, and then exit the PDCCH blind detection.

Preferably, the terminal further includes a third module 903, which is configured to record whether the terminal is in an RRC_Connected state or RRC_Idle state.

### Embodiment 5

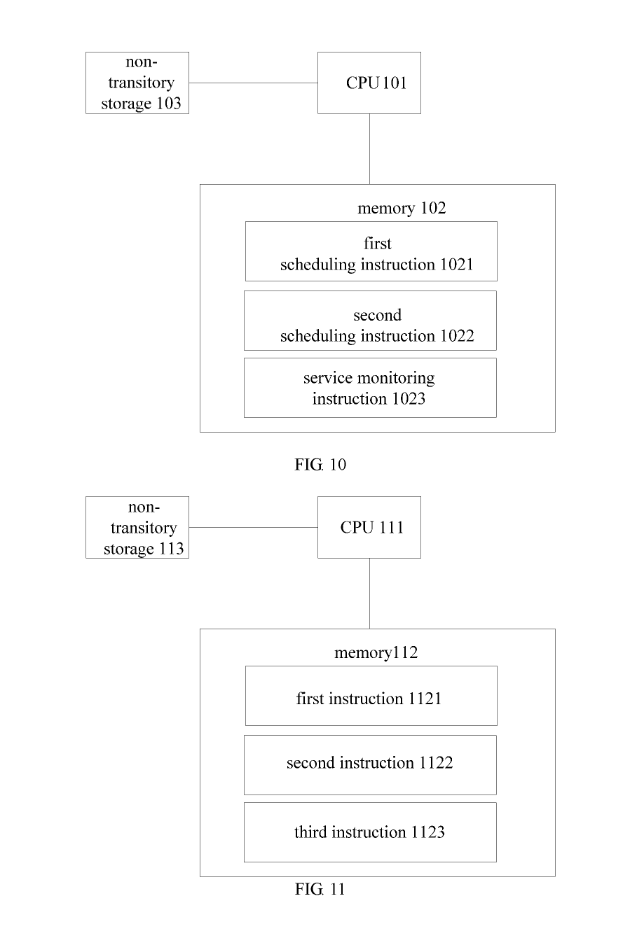

As shown in FIG. 10, the present disclosure also discloses an apparatus for processing a downlink control channel. The apparatus includes a central processing unit (CPU) 101, a memory 102 and a non-transitory storage 103.

The non-transitory storage 103 is configured to store a computer program, which may realize processing of the downlink control channel.

The CPU 101 is configured to load the computer program from the non-transitory storage 103 into the memory 102 to be run, so as to form computer executable instructions. The computer executable instructions include a first scheduling instruction 1021 and a second scheduling instruction 1022.

The first scheduling instruction 1021 indicates to schedule a group call service, which includes as follows. In a downlink TTI, when a UE within a group call has an individual service to be scheduled, the first scheduling instruction 1021 indicates to schedule the group call service within the public space, by using G-RNTI or SPS G-RNTI. Still in the downlink TTI, when each UE within the group call has no individual service to be scheduled, the first scheduling instruction 1021 indicates to schedule the group call service within the dedicated space, by using G-RNTI or SPS G-RNTI. In the downlink TTI, when a UE within such group call has an individual service to be scheduled, the second scheduling instruction 1022 indicates to schedule the individual service of the UE within the dedicated space, by using C-RNTI or SPS C-RNTI.

Furthermore, the computer executable instructions also include a service monitoring instructions 1023, which indicates to monitor in a downlink TTI, whether a UE of the group call in a cell has an individual service to be scheduled. The monitoring includes as follows. Learn from a network side, whether the UE having an individual service to be scheduled belongs to the group call; or learn from the network side the UE participating in the group call, and monitor, whether a UE having an individual service to be scheduled within the cell, belongs to the group call.

The scheduling is a dynamic scheduling or SPS. There is at least one group call service. In the downlink TTI, there is at least one UE having an individual service to be scheduled. The individual service is a point-to-point service.

### Embodiment 6

As shown in FIG. 11, the present disclosure also discloses a terminal, which includes a CPU 111, a memory 112 and a non-transitory storage 113.

The non-transitory storage 113 is configured to store a computer program, which may realize processing of a downlink control channel.

The CPU 111 is configured to load the computer program from the non-transitory storage 113 into the memory 112 to be run, so as to form computer executable instructions. The computer executable instructions include a first instruction 1121.

The first instruction 1121 indicates to perform a PDCCH blind detection within public space of a downlink TTI, by using G-RNTI or SPS G-RNTI. When not detecting the G-RNTI and SPS G-RNTI within the public space, the first instruction 1121 indicates to continuously perform the PDCCH blind detection within dedicated space, and then exit the PDCCH blind detection.

Furthermore, when detecting G-RNTI or SPS G-RNTI within the public space, and the terminal is in an RRC_Idle state, the first instruction 1121 also indicates to exit the PDCCH blind detection.

The computer executable instructions further include a second instruction 1122. When detecting the G-RNTI or SPS G-RNTI within the public space, during the process of performing the PDCCH blind detection, and the terminal is in an RRC_Connected state, the second instruction 1122 indicates to perform the PDCCH blind detection within the dedicated space, by using C-RNTI or SPS C-RNTI, and then exit the PDCCH blind detection.

The computer executable instructions further include a third instruction 1123, which indicates to record whether the terminal is in an RRC_Connected state or RRC_Idle state.

The present disclosure also provides a system for processing a downlink control channel. The system includes an apparatus for processing a downlink control channel and a terminal described above.

As can be seen from the above embodiments, by adopting the method, apparatus and system for processing a downlink control channel in the present disclosure, concurrent scheduling of multiple groups of cluster services may be supported, gain of a cluster service system may be improved. Meanwhile, it is not necessary for a UE to perform additional blind detections, thereby reducing searching complexity of the UE.

What is described in the foregoing are only some embodiments of the present disclosure, and should not be construed as limitations to the present disclosure. Any modifications, equivalent substitutions, and improvements made within the spirit and principle of the present disclosure should be covered by the protecting scope of the present disclosure.

1. A method for processing a downlink control channel, comprising:
under the circumstances that there is a service of group call to be scheduled in a downlink transmit time interval (TTI),
when a user equipment (UE) of the group call within a cell has an individual service to be scheduled in the downlink TTI,
scheduling, by a sender, the service of the group call in public space, by using a Group Radio Network Temporary Identifier (G-RNTI) or a Semi-Persistent Scheduling (SPS) G-RNTI, and scheduling the individual service of the UE within dedicated space, by using a Cell Radio Network Temporary Identifier (C-RNTI) or a SPS C-RNTI;
when each UE of the group call within the cell has no individual service to be scheduled in the downlink TTI, scheduling, by the sender, the service of the group call within the dedicated space, by using the G-RNTI or the SPS G-RNTI.

2. The method of claim 1, wherein the scheduling is a dynamic scheduling or the SPS.

3. The method of claim 1, wherein there is at least one service of the group call.

4. The method of claim 1, wherein there is at least one UE having the individual service to be scheduled in the downlink TTI.

5. The method of claim 1, wherein the UE having the individual service to be scheduled in the downlink TTI is in a Radio Resource Control_Connected (RRC_Connected) state.

6. The method of claim 1, further comprising:
before scheduling by the sender the service of the group call, determining whether there is a UE of the group call having an individual service to be scheduled in the downlink TTI;
wherein determining whether there is the UE of the group call having the individual service to be scheduled in the downlink TTI comprise:
learning from a network side whether the UE having the individual service to be scheduled belongs to the group call; or, learning from the network side the UE participating in the group call, monitoring the UE within the cell having the individual service to be scheduled, and determining whether the UE belongs to the group call.

7. The method of any of claim 1, wherein the individual service is a point-to-point service.

8. An apparatus for processing a downlink control channel, comprising a first scheduling module and a second scheduling module,
when there is a service of a group call to be scheduled in a downlink Transmit Time Interval (TTI), the first scheduling module is to schedule the service of the group call, which comprises:
when a user equipment (UE) of the group call has an individual service to be scheduled in the downlink TTI, schedule the service of the group call within public space, by using a Group Radio Network Temporary Identifier (G-RNTI) or a Semi-Persistent Scheduling (SPS) G-RNTI;
when no UE of the group call has an individual service to be scheduled in the downlink TTI, schedule the service of the group call within dedicated space, by using the G-RNTI or the SPS G-RNTI;
when a UE of the group call has an individual service to be scheduled in the downlink TTI, the second scheduling module is to schedule the individual service of the UE within the dedicated space, by using a Cell Radio Network Temporary Identifier (C-RNTI) or a SPS C-RNTI.

9. The apparatus of claim 8, wherein the apparatus further comprises a service monitoring module, which is to monitor whether each UE of the group call in a cell has an individual service to be scheduled in the downlink TTI, inform the first scheduling module and the second scheduling module.

10. The apparatus of claim 9, wherein the monitoring comprises:
learning from a network side whether the UE having the individual service to be scheduled belongs to the group call; or,
learning from the network side the UE participating in the group call, monitoring the UE of the cell having the individual service to be scheduled, and determining whether the UE belongs to the group call.

11. The apparatus of claim 8, wherein the scheduling is a dynamic scheduling or a SPS.

12. The apparatus of claim 8, wherein there is at least one service of the group call.

13. The apparatus of claim 8, wherein there is at least one UE having the individual service to be scheduled in the downlink TTI.

14. The apparatus of claim 8, wherein the individual service is a point-to-point service.

15. A method for processing a downlink control channel, comprising:
performing, by a user equipment (UE), a physical downlink control channel (PDCCH) blind detection within public space in a downlink Transmit Time Interval (TTI), by using a Group Radio Network Temporary Identifier (G-RNTI) or a Semi-Persistent Scheduling (SPS) G-RNTI;
when not detecting the G-RNTI and the SPS G-RNTI, continuously performing, by the UE, the PDCCH blind detection within dedicated space, and exiting the PDCCH blind detection.

16. The method of claim 15, further comprising:
when detecting the G-RNTI or the SPS G-RNTI within the public space by the UE, and the UE is in a radio resource control_Idle (RRC_Idle) state, exiting the PDCCH blind detection.

17. The method of claim 15, further comprising:
when detecting the G-RNTI or the SPS G-RNTI within the public space by the UE, and the UE is in an RRC_Idle state, continuously performing the PDCCH blind detection within the dedicated space, by using a Cell Radio Network Temporary Identifier (C-RNTI) or a SPS C-RNTI, and exiting the PDCCH blind detection.

18.-22. (canceled)
